(19) United States
(12) Patent Application Publication
(10) Pub. No.: US 2019/0012749 A1
(43) Pub. Date: Jan. 10, 2019

(54) DYNAMIC COST FUNCTION CALCULATION FOR AGRICULTURAL USERS

(71) Applicant: International Business Machines Corporation, Armonk, NY (US)

(72) Inventors: Samuel Mathew Jawaharlal, Chennai (IN); Arunachalam Narayanan, Chennai (IN); Sathya Santhar, Chennai (IN); Balamurugaramanathan Sivaramalingam, Ramanathapuram (IN)

(21) Appl. No.: 15/641,674

(22) Filed: Jul. 5, 2017

(51) Int. Cl. G06Q 50/02; G06Q 10/06; G06K 9/00

(52) U.S. Cl. CPC G06Q 50/02; G06K 2209/17; G06K 9/00657; G06Q 10/0631

(57) ABSTRACT

The dynamic estimation of the cost functions involved in agriculture to determine which crops will result in the best return on investment given local conditions. A user interface allows a user to define a predetermined geographic area for analysis. A processor retrieves historical data encompassing the predetermined geographic area from a database and crop yield factor information from aerial images of the area and uses that information to calculate a minimized cost function for any particular crop to be grown in the area. A user may also select sub-areas for further analysis, for intercropping, and to assess the cost functions for multiple crops.

### BACKGROUND

The present invention relates to agricultural cost function calculation and, more specifically, to dynamic estimation of cost functions in given geographical regions.

The challenge of agricultural sustainability has become more intense in recent years with the sharp rise in the cost of food and energy, climate change, water scarcity, degradation of natural ecosystems and biodiversity, the financial crisis, and the expected increase in population. As a result, accurate and timely estimation of crop/grain yield is important for variety of reasons, including for crop insurance purposes, delivery estimates, planning harvest and storage requirements, and cash-flow budgeting. Conventional estimation of crop yield involves consideration of the relationship established between factors affecting/influencing crop growth and crop yield. There are a number of known techniques, such as statistical methods (weighted average, extrapolation etc.), empirical models based on weather data, models built based on remote sensing data (NDVI), and linear regression models. The existing methodologies for estimating crop yields have several disadvantages, however, and often depend on the scale of estimation and available resources.

For example, whole plot harvesting may be suitable for small scale detailed studies at plot level, while large scale surveys at regional levels may require combine crop cut, farmer estimations, and expert assessment. Use of these various crop models and remote sensing may often be appropriate for agricultural statistics, provided that adequate parameterization of models is performed and imagery is available at sufficiently fine resolution to capture the variability of crops and their performance in smallholder fields. Precise estimation of crop yield in smallholder agriculture is challenging because of highly heterogeneous crop performance within a plot, continuous planting and intercropping, or mixed cropping that may be employed to meet the various requirements and changing constraints on the farmers. For example, within a defined region, there may be yield variations due to differences in many sub-areaal parameters. In addition, yields may vary depending on local constraints such as planting and maintenance costs, irrigation types, etc. that may vary during different stages of the crop or between different crops planted in the same area. Accordingly, there is a need in the art for an approach that can perform dynamic estimation of the cost functions involved in agriculture on a plot specific basis.

### SUMMARY

One embodiment of the invention is a system for performing a dynamic estimation of the cost functions involved in agriculture that has a user interface adapted to allow a user to define a predetermined geographic area for analysis, a database containing historical data encompassing the predetermined geographic area, an image analyzer for processing at least one image of the predetermined geographic area to extract data relevant to crop yield, and a processor associated with the user interface, the database, and the image analyzer. The processor is programmed to calculate a minimized cost function a crop to be grown in at least a first geographical coordinate within the predetermined geographic area based on the historical data of the predetermined geographic area and the analysis of images of the predetermined geographic area. The processor may also be programmed to determine an average of the minimized cost functions for a plurality of geographical coordinates within the predetermined geographic area. The processor may further be programmed to determine a second minimized cost function for a second crop to be grown in at least a second geographical coordinate within the predetermined geographic area based on the historical data of the predetermined geographic area and the analysis of images of the predetermined geographic area. The processor may additionally be programmed to allow a user to input at least one constant parameter for use for in calculating the minimized cost function. The processor may also be programmed to allow a user to designate a sub-area within the predetermined geographic area and to calculate an average minimized cost function just within the sub-area. The processor may further be programmed to allow a user to recalculate the minimized cost function after a crop has been planted based on new data obtained from the user interface, the image analyzer, or the database.

Another embodiment of the invention is a method of dynamically estimating the cost functions involved in agriculture. The method includes allowing a user to define a predetermined geographic area for analysis, retrieving historical data encompassing the predetermined geographic area from a database, using an image analyzer to process at least one image of the predetermined geographic area to extract data relevant to crop yield, and using a processor associated with the user interface, the database, and the image analyzer programmed to calculate a minimized cost function a crop to be grown in at least a first geographical coordinate within the predetermined geographic area based on the historical data of the predetermined geographic area and the analysis of images of the predetermined geographic area. The method can include using the processor to determine an average of the minimized cost functions for a plurality of geographical coordinates within the predetermined geographic area. The method can also include using the processor to determine a second minimized cost function for a second crop to be grown in at least a second geographical coordinate within the predetermined geographic area based on the historical data of the predetermined geographic area and the analysis of images of the predetermined geographic area. The method may additionally include allowing a user to input at least one constant parameter for use for in calculating the minimized cost function. The method may further include allowing a user to designate a sub-area within the predetermined geographic area and using the processor to calculate an average minimized cost function just within the sub-area. The method may also include using the process to recalculate the minimized cost function after a crop has been planted based on new data obtained from the user interface, the image analyzer, or the database.

A further embodiment of the invention may be a computer program product for dynamically estimating the cost functions involved in agriculture comprising a computer readable storage medium having program instructions embodied therewith, the program instructions executable by a computing device to cause the computing device to perform a method of dynamically estimating the cost functions involved in agriculture as described above.

### BRIEF DESCRIPTION OF THE DRAWINGS

FIG. 1 is a schematic of a system for assessing minimized cost functions across a user owned agricultural area according to the present invention;

FIG. 2 a flowchart of an approach for assessing minimized cost functions across a user owned agricultural area according to the present invention;

FIG. 3 is a schematic of a user owned agricultural area employing minimized cost functions according to the present invention;

FIG. 4 is a schematic of the introduction of sub-areas within user owned agricultural area employing minimized functions according to the present invention; and

FIG. 5 is a schematic of the calculation of cost functions in a user owned agricultural area based on a first proposed utilization of the area according to the present invention; and

FIG. 6 is schematic of is a schematic of the calculation of cost functions in a user owned agricultural area based on additional plantings combined with an first proposed utilization of the area according to the present invention.

### DETAILED DESCRIPTION

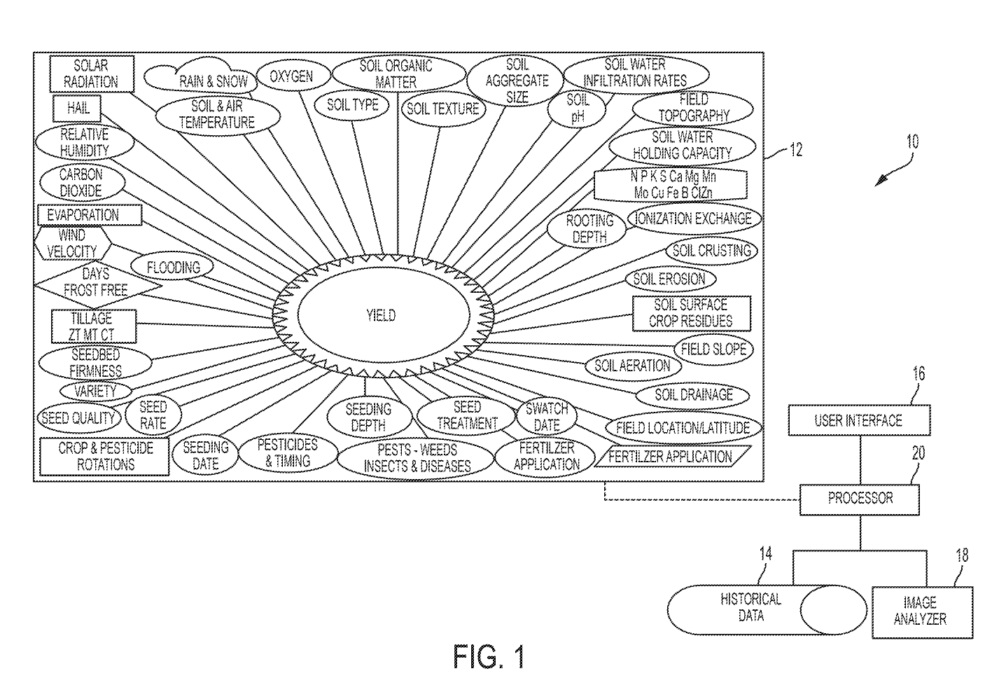

Referring to the figures, wherein like numerals refer to like parts throughout, there is seen in FIG. 1, a system 10 for assessing minimized cost functions across a user owned agricultural area according to the present invention based on one or more factors 12 that contribute to crop yield and are used an input. System 10 further comprises a database of historical data 14 for a given geographical area, such as climate, temperature, vegetation, water levels, etc., as well as a user interface 16 for displaying, among other things, geographical maps, calculations of the cost functions and allowing user input.

System 10 additionally includes an image analyzer 18 for identifying in a predetermined geographic region the types of vegetation, the healthiness of plants, the plant density, and other relevant crop characteristics using spectral reflectance properties in the infrared region of the spectrum. For example, conventional satellite image analysis techniques employing pre-processing, image enhancement based on histogram scrutiny, multispectral imaging, and special feature extraction can be used to identify the status of the relevant factors in a geographic area. In addition, special techniques for evaluating crop factor in images have been developed, such as the use of vegetation indexes deduced from fitted double-Gaussian curves, and may be employed by image analyzer 18. A central processor 20 is interconnected to user interface 16, historical database 14, and image analyzer 18 to process the relevant information according to crop yield factors 12 and determine the cost functions associated with a particular utilization of a target geographic area.

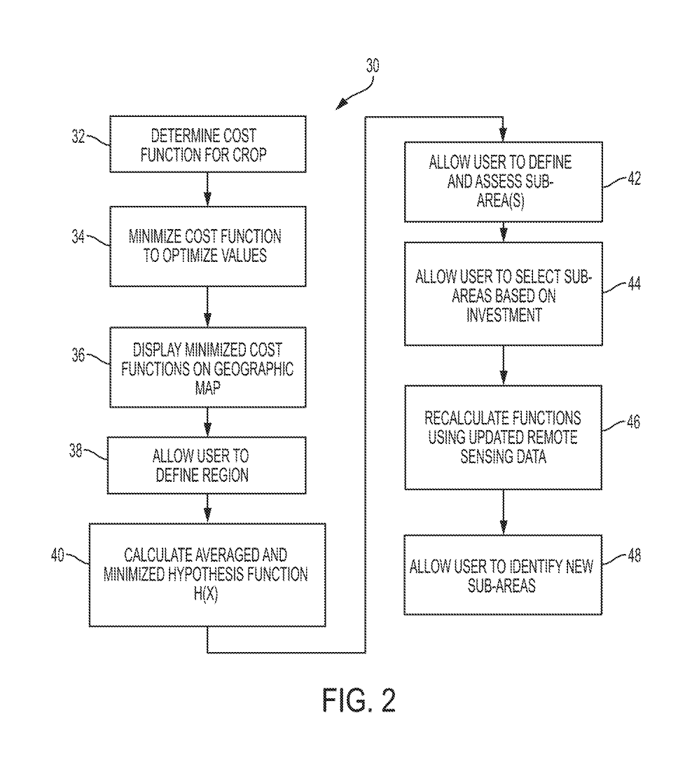

Referring to FIG. 2, system 10 is configured to implement a method 30 for assessing the costs function associated with the proposed agricultural usage of a given plot of land. First, the particular cost function for a given crop or set of crops is determined 32 using the relevant factors seen in FIG. 1. For example, through remote sensing satellite data, image processing and available historical data for a particular place, the different dependent variables associated with each crop are used to derive the function h(θ, x) associated with the global positioning system (GPS) coordinates for the site (φ, λ) (where φ is latitude and λ is longitude). Image analysis techniques can also identify the type of vegetation, healthiness of plants, density and other characteristics by using spectral reflectance properties in the infrared region of the spectrum. Thus,

h(θ,x(φ,λ))=θ₀+θ₁x₁+θ₂x₂+ . . . +θₙxₙ

where θ₀, θ₁, . . . , θₙ are the weightage factors, x₁, x₂, . . . xₙ are the dependent variables (such as soil, water, cost, etc.). The weightages for each of the variables are thus obtained in such a way that the cost function is minimized, such as how the minimization approach is implemented in any supervised/unsupervised learning context using a linear regression—implementation.

Certain variables are linear (e.g., cost) whereas certain other variables are logistic classifiers. For example, if irrigation is variable, ‘1’ may be used to denotes drip irrigation and ‘2’ denotes well irrigation, etc. Based on the dependencies, the dependent variables may be re-aligned to arrive at a multipolynomial quadratic function, which can be quadratic, cubic, quartic. As an example, if x₁ is cost and x₂ is pesticide, then one constituent of the hypothesis function would be θ₂x₁²x₂³. Hence the redefined function can be:

h(θ,x(φ,λ))=θ₀+θ₁x₁x₂+θ₂x₂²+θ₃x₃x₄x₅ . . . +θₙxₙ

In addition to GPS coordinate based data collection, crop impacting factors for each crop may be collected and associated with the cost function for each of the GPS coordinates so that minimized cost function can be constructed for any area selected by the user by aggregating the parameters associated to the GPS coordinates. Thus, a user can select any crop based on desired constraints that would give a maximum yield within the timeframe for the area. Historical training data and machine learning may be used for prediction to increase the accuracy of prediction as crop impacting factors are associated to each GPS coordinate. Existing data repositories may be used to supply information about the impact of relevant factors on a given crop, such as the Krishi Technology Repository and the U.S. Department of Agriculture computer model decision support system.

Once the cost function has been determined, it is minimized 34 to arrive at the optimized values of θ₀, θ₁, . . . , θₙ for each GPS coordinate. The function can be same for nearby areas as the next adjacent fifty co-ordinates may have the same function. This step can be repeated for every crop hᵢ(θ, x) where i denotes the ith crop. For simplicity, one function h(x) is used as an example.

Several methods may be used to reduce any overfitting, such as reducing the number of features, e.g., manually or by using a model and feature selection algorithm, or regularization that keeps all the factors but reduces the magnitude and values of parameters such as by adding huge values to the hypothesis function.

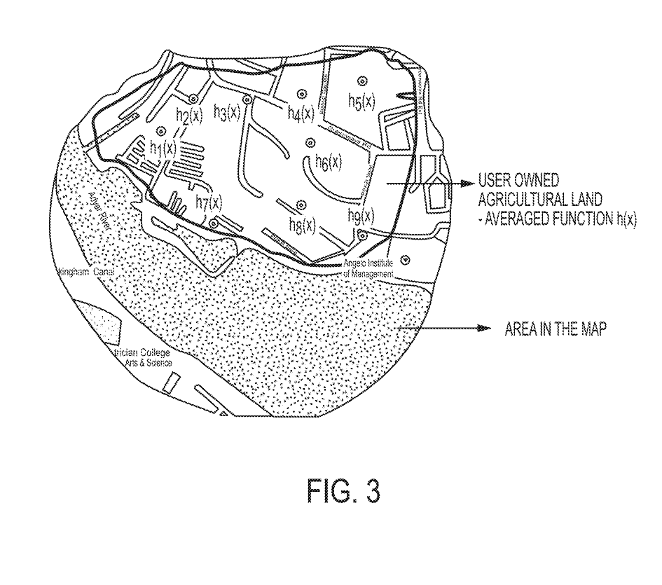

A user, which may be the owner/farmer, government entity, etc., may view the resulting functions on an interactive map of the particular area 34 to identify the maximum yield at a particular area, as seen in FIG. 3. The user may then define a particular area within the map 38, such as by encircling the defined area graphically. Once the encircled region is identified, an averaged and minimized hypothesis function h(x) may be calculated for the encircled region 40. In FIG. 3, each hypothesis function h(x) would be different even though they are very close due to micro-regional differences, e.g., function h₇(x) describes land near a river and thus has different water issues, function h₉(x) defines land in a shady area due to nearby buildings. Thus, a user can select an area near a water source and can get the averaged function for that portion if the user decides to cultivate only that portion of the land during that timeframe.

A user may set constant parameters such as x₁ as a cost parameter of 10,000 (maximum amount that can be spent on the plot), x₂ as an irrigation parameter of 2 denoting well irrigation. A limit may be set for factors, for example, if the crop is maize, x₃ can represent an allowable temperature range of greater than 4° C. and less than 42° C. The maximum yield may be set, such as h(x)=20,000. Based on all these constraints, the functions may be recalculated as follows.

h(θ,x(φ,λ))_{recalc}=θ₀+θ₁x₁x₂+θ₂x₂²+θ₃x₃x₄x₅ . . . +θₙxₙ

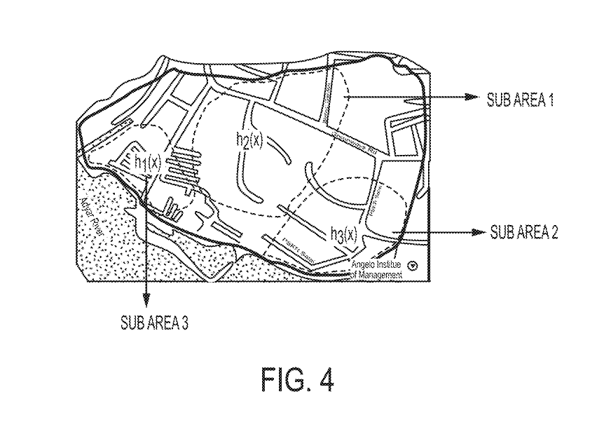

Referring to FIG. 4, a user may define and then select any number of sub-areas 42 to assess the costs associated with farming different crops in those sub-areas to determine the most cost-effective usage of each sub-area. For example, as sub-area 3 is close to the river, crop A might give the highest yield and thus best cost function. By contrast, sub-area 1 might have a different crop that will produce the highest yield and cost function. Alternatively sub-areas may be automatically selected based on common cost function and crop.

Method 30 may also allow a user to select sub-areas based on planned investments 44. For example, a user can plan to invest 1,000 at the outset and an additional 1000 after a set period of time such as three months. Based on the variable factors, such as the availability of water which can change depending on the season, sub-area 3 may offer the best cost function at the initial outset with sub-area providing the best cost function if planted after the set time period.

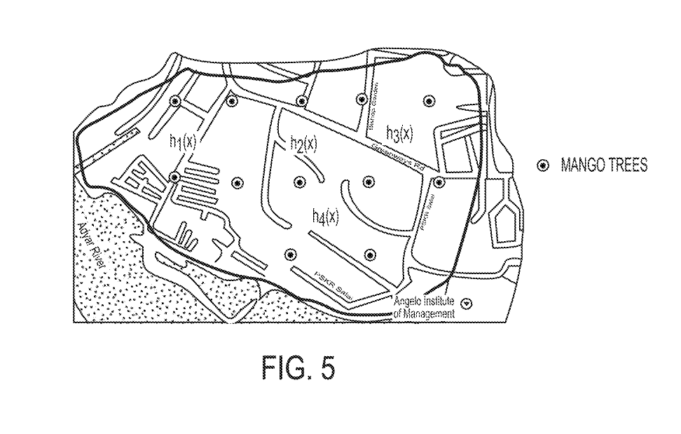

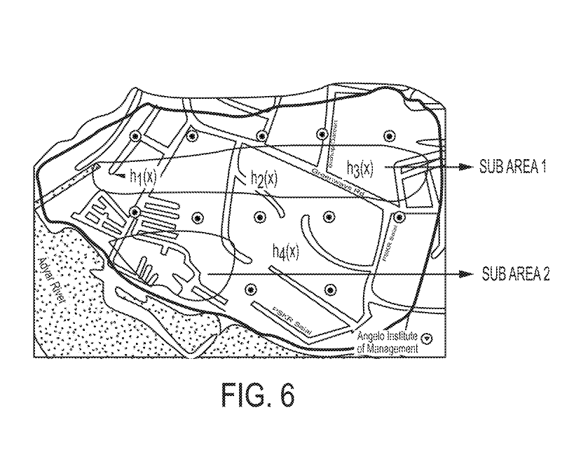

Method 30 may additionally allow for recalculation of all functions during the farming period by using updated remote sensing data 46. Referring to FIG. 5, the functions hᵢ(x) . . . h₄(x) would be changed due to the planting of an exemplary number of mango trees and the resulting changes in water level, soil fertility, sunlight, etc. Subsequent recalculation of the functions can reveal any changes in the cost functions. Referring to FIG. 6, a user may identify new sub-areas for additional farming 48 that are integrated with previously defined sub-areas. As seen in FIG. 6, a user has selected the areas between the mango trees of FIG. 5 for farming. The functions may now be minimized within the sub-areas to arrive at the maximum yield with the changes causes by the planting of the trees taken into account (via image analysis or manual inspection) along with a condition that the hypothesis functions of current farming areas should not be disturbed or altered, i.e., planting in the new sub-areas will give a maximum yield without affecting the maximum yield for the mango trees.

### EXAMPLE

As an example, the analysis for the production of cotton may involve consideration of the following factors:
Temperature—X₁
Type of irrigation—X₂
Amount spent (on Fertilizers, manures, maintenance and management etc.)—X₃
Season—X₄
Soil fertility score (based on previous crops planted)—X₅
Soil pH level—X₆
Average daily rainfall—X₇
   Construction of a general hypothesis function for cotton would contain different input values and the corresponding outputs for cotton as follows:

h(θ)=θ₀+θ₁x₁+θ₂x₂+θ₃x₃+θ₄x₄+θ₅x₅
where θ₀, θ₁, θ₂, θ₃, θ₄, θ₅ are the weightage factors
   Certain variables are linear, such as temperature, while other variables have fixed values for different categories, e.g., the type of irrigation may use 1 for well irrigation and 2 for drip irrigation.

With the constraints X₂=2 and X₃=10,000, i.e., the farmer has well irrigation and can spend maximum of $10,000 dollars for the crop, the equation becomes:

h(θ)=θ₀+θ₁x₁+2θ₂+10000θ₃+θ₄x₄+θ₅x₅

The cost function has to be minimized to arrive at the values of θ. The following are the θ values for the minimized cost function considering the training set:

θ₀=1.23, θ₁=20.2, θ₂=13.3, θ₃=14.5, θ₄=6, θ₅=8

The hypotheses function may be different for different areas within a location, as some of the variables like average daily rainfall, season may be the same, but some variables like temperature, soil nutrients might be different (e.g., one area of the farm is a shaded region while other areas are in the sun). As a result, hypotheses functions for the different geographic coordinates are constructed and associated to each geographic coordinate (φ, λ) (where φ—Latitude and λ—Longitude) as follows

h(θ,x(φ,λ))=θ₀+θ₁x₁+2θ₂+10000θ₃+θ₄x₄+θ₅x₅

Thus, the equation will be different for each geo co-ordinate, e.g., for φ—41°24′12.2″N and λ—2°10′26.5″E, the values of X5 and X6 may be 40 and 6.2, whereas for φ—32°12′13.4″N and λ—21°1′15.5″E, the values of X5 and X6 may be 52 and 3.6.

The above steps can be repeated for every crop hi(θ, x) where i denotes the ith crop. When a user looks at a map to identify the maximum yield at a particular area, the user can encircle an area for possible cultivation. The hypotheses functions of different geographic coordinates within the selected boundary are averaged to arrive at the averaged hypothesis function h(x).
For example, for cotton,

h1=1.23+20.2X₁+26.6+14500+6X₄+8X₅

h2=0.26+12.6X₁+26.6+14500+0.02X₄+16.7X₅ etc.

averaged function h(x)=1.32+16.8X₁+26.6+14500+3.4X₄+0.45X₅
For maize,

h1=0.56+1.2X₁+26.6+14500+5.4X₄+6.7X₅

h2=0.43+6.4X₁+26.6+14500+3.6X₄+8.7X₅ and so on

averaged function h(x)=0.67+52.4X₁+26.6+14500+8.3X₄+6.8X₅

System 10 may thus calculate the output value for each crop in the selected location and provide an indication of the crop with the maximum yield. For example, if (cotton)=145.3 and h(maize)=600, maize would be identified as the better crop to plant. After planting is commenced, system 10 may be used to recalculate and reconsider the evaluation using updated remote sensing data and provide a better yield estimate. For example, the functions h1(x), . . . h4(x) may change due to the planting of other crops that impact available sunlight, change in the water level, changed in soil fertility, etc.

The descriptions of the various embodiments of the present invention have been presented for the purposes of illustration, but are not intended to be exhaustive or limited to the embodiments disclosed. Many modification and variations will be apparent to those of ordinary skill in the art without departing from the scope and spirit of the described embodiments. The terminology used herein was chosen to best explain the principles of the embodiments, the practical application or technical improvement over the technologies found in the market place, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for performing a dynamic estimation of the cost functions involved in agriculture, comprising:
a user interface adapted to allow a user to define a predetermined geographic area for analysis;
a database containing historical data encompassing the predetermined geographic area;
a image analyzer for processing at least one image of the predetermined geographic area to extract data relevant to crop yield; and
a processor associated with the user interface, the database, and the image analyzer programmed to calculate a minimized cost function a crop to be grown in at least a first geographical coordinate within the predetermined geographic area based on the historical data of the predetermined geographic area and the analysis of images of the predetermined geographic area.

2. The system of claim 1, wherein the processor is programmed to determine an average of the minimized cost functions for a plurality of geographical coordinates within the predetermined geographic area.

3. The system of claim 2, wherein the processor is programmed to determine a second minimized cost function for a second crop to be grown in at least a second geographical coordinate within the predetermined geographic area based on the historical data of the predetermined geographic area and the analysis of images of the predetermined geographic area.

4. The system of claim 3, wherein the processor is programmed to allow a user to input at least one constant parameter for use for in calculating the minimized cost function.

5. The system of claim 4, wherein the processor is programmed to allow a user to designate a sub-area within the predetermined geographic area and to calculate an average minimized cost function just within the sub-area.

6. The system of claim 5, wherein the processor is programmed to allow a user to recalculate the minimized cost function after a crop has been planted based on new data obtained from the user interface, the image analyzer, or the database.

7. A method of dynamically estimating the cost functions involved in agriculture, comprising:
allowing a user to define a predetermined geographic area for analysis;
retrieving historical data encompassing the predetermined geographic area from a database;
using an image analyzer to process at least one image of the predetermined geographic area to extract data relevant to crop yield; and
using a processor associated with the user interface, the database, and the image analyzer programmed to calculate a minimized cost function a crop to be grown in at least a first geographical coordinate within the predetermined geographic area based on the historical data of the predetermined geographic area and the analysis of images of the predetermined geographic area.

8. The method of claim 7, further comprising using the processor to determine an average of the minimized cost functions for a plurality of geographical coordinates within the predetermined geographic area.

9. The method of claim 8, further comprising using the processor to determine a second minimized cost function for a second crop to be grown in at least a second geographical coordinate within the predetermined geographic area based on the historical data of the predetermined geographic area and the analysis of images of the predetermined geographic area.

10. The method of claim 9, further comprising allowing a user to input at least one constant parameter for use for in calculating the minimized cost function.

11. The method of claim 10, further comprising allowing a user to designate a sub-area within the predetermined geographic area and using the processor to calculate an average minimized cost function just within the sub-area.

12. The method of claim 11, further comprising using the process to recalculate the minimized cost function after a crop has been planted based on new data obtained from the user interface, the image analyzer, or the database.

13. A computer program product for dynamically estimating the cost functions involved in agriculture comprising a computer readable storage medium having program instructions embodied therewith, the program instructions executable by a computing device to cause the computing device to perform a method of forming panoramic video comprising:
allowing a user to define a predetermined geographic area for analysis;
retrieving historical data encompassing the predetermined geographic area from a database;
processing at least one image of the predetermined geographic area to extract data relevant to crop yield; and
calculating a minimized cost function a crop to be grown in at least a first geographical coordinate within the predetermined geographic area based on the historical data of the predetermined geographic area and the analysis of images of the predetermined geographic area

14. The computer program product of claim 13, wherein the method further comprises using the processor to determine an average of the minimized cost functions for a plurality of geographical coordinates within the predetermined geographic area.

15. The computer program product of claim 14, wherein the method further comprises using the processor to determine a second minimized cost function for a second crop to be grown in at least a second geographical coordinate within the predetermined geographic area based on the historical data of the predetermined geographic area and the analysis of images of the predetermined geographic area.

16. The method of claim 15, wherein the method further comprises further comprises allowing a user to input at least one constant parameter for use for in calculating the minimized cost function.

17. The method of claim 16, wherein the method further comprises further comprises allowing a user to designate a sub-area within the predetermined geographic area and using the processor to calculate an average minimized cost function just within the sub-area.

18. The method of claim 17, wherein the method further comprises further comprises using the process to recalculate the minimized cost function after a crop has been planted based on new data obtained from the user interface, the image analyzer, or the database.
